(19) United States
(12) Patent Application Publication
(10) Pub. No.: US 2009/0145010 A1
(43) Pub. Date: Jun. 11, 2009

(54) INNER SCATTERING BILLBOARD

(76) Inventors: Chao-Fang CHUNG, Taichung County (TW); Yu-Nan Liu, Taichung County (TW); Chung-Ying Yu, Taichung County (TW); Cheng Hsu, Taichung-County (TW); Ming-Chun Lin, Taichung-County (TW); Yung-Liang Chang, Taichung-County (TW); Pei-Yu Hsu, Taichung-County (TW)

Correspondence Address: Joe McKinney Muncy, PO Box 1364, Fairfax, VA, 22038-1364, US

(21) Appl. No.: 11/951,020

(22) Filed: Dec. 5, 2007

(51) Int. Cl. G09F 13/00

(52) U.S. Cl. 40/541

(57) ABSTRACT

An inner scattering billboard includes a light directing body, an advertising membrane and a light source. The light directing body contains a plurality of light directing particles inside to diffuse and direct light. Thus light rays emitted from the light source into the light directing body are scattered to allow the light directing body to become a planar light source of even luminosity. The advertising membrane has an advertising symbol located on the surface to be evenly illuminated. The billboard can be made thinner. An LED may be adopted as the light source to save electric power and reduce user's operation cost.

### FIELD OF THE INVENTION

The present invention relates to a billboard and particularly to a thin billboard that can emit light evenly and save energy.

### BACKGROUND OF THE INVENTION

Billboards are important commercial media to promote business brands and products. Referring to FIG. 1, a commonly used conventional billboard includes a chest 1 made from plastics such as acrylic with advertising symbols 3 attached to the surface thereof and a lighting element such as a fluorescent lamp 2 located in the chest 1. Through the light generated by the fluorescent lamp 2 and the advertising symbols 3 on the surface of chest 1 attention soliciting effect can be achieved to accomplish commercial purpose.

In the conventional luminous billboard the chest 1 has to be made at a selected thickness to hold the fluorescent lamp 2. Hence it takes a lot of space and often is quite heavy. Light generated by the fluorescent lamp 2 in the chest 1 often is not evenly projected. Local luminosity difference occurs. People's visual feeling could be disturbed and deciphering could suffer. It makes advertising less effective. To make the luminosity of the chest 1 more uniform, more florescent lamp 2 is required. This results in more electric power consumption and higher user's operation cost.

### SUMMARY OF THE INVENTION

Therefore the primary object of the present invention is to provide a thin, energy-saving and even luminous billboard to reduce user's operation cost and improve advertising effect.

The present invention provides an inner scattering billboard which includes a light directing body, an advertising membrane and a light source. The light directing body has at least one incident surface and at least one emitting surface. The light directing body contains a plurality of light directing particles that are scattered inside. The light source is located close to the incident surface to emit light to enter the light directing body. The advertising membrane is bonded closely to the emitting surface and has an advertising symbol located on an outer side thereof.

By means of the aforesaid structure the light directing body provides an even planar light source. Coupled with the advertising symbol on the advertising membrane a luminous billboard is formed. Compared with the conventional billboard, the invention provides more benefits such as even luminosity, thin and light, and energy saving. It also can reduce user's operation cost and improve advertising effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional luminous billboard.

FIG. 2A is a perspective view of the invention.

FIG. 2B is a cross section taken on line 2B-2B in FIG. 2A.

FIG. 3 is a cross section of another embodiment of the invention.

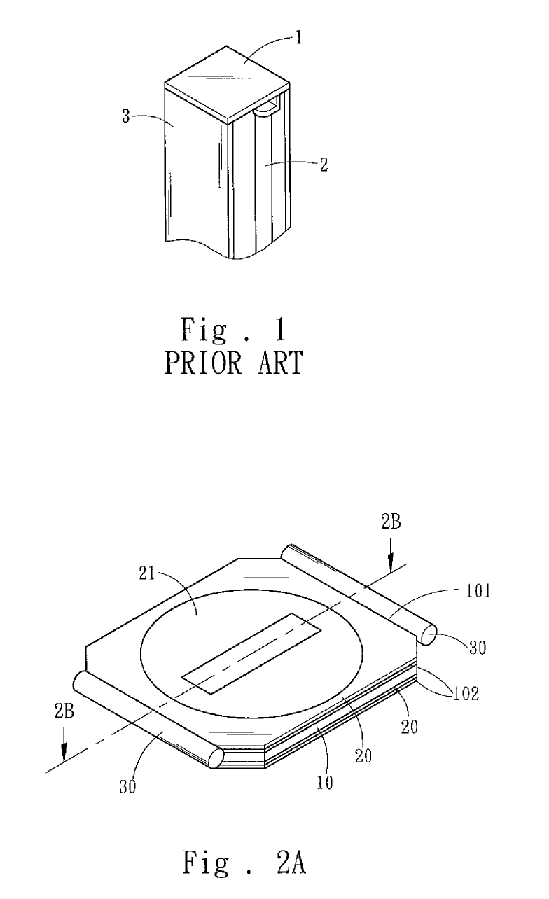

### DETAILED DESCRIPTION OF THE PREFERRED EMBODIMENTS

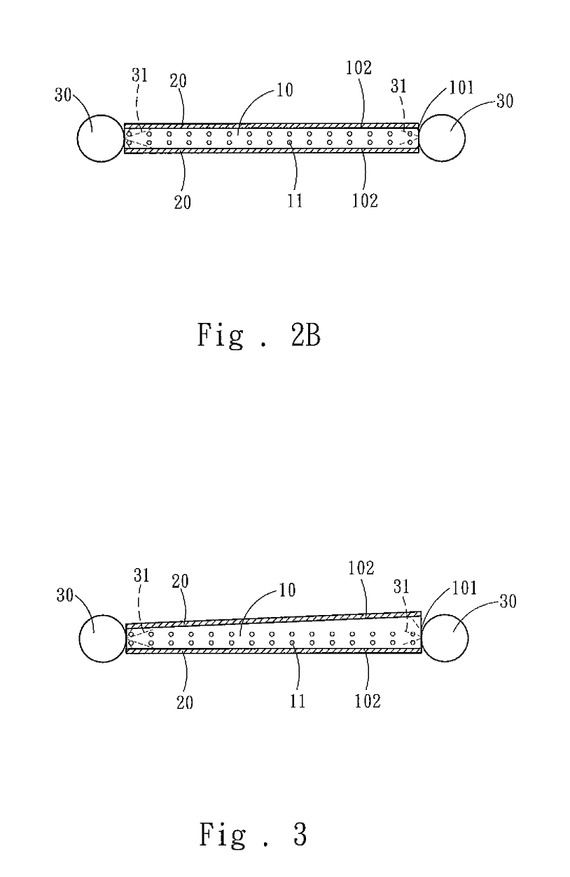

Please referring to FIGS. 2A and 2B, the inner scattering billboard according to the invention includes a light directing body 10, an advertising membrane 20 and a light source 30. The light directing body 10 has at least one incident surface 101 and one emitting surface 102, and contains a plurality of light directing particles 11 inside in a scattering fashion. The light source 30 is a light emitting diode (LED) or a cold cathode fluorescent lamp (CCFL). In an embodiment shown in the drawings, the light directing body 10 is a flat panel. FIG. 3 illustrates another embodiment in which the light directing body 10 is a slant panel. The emitting surface 102 is formed respectively at an upper side and a lower side of the light directing body 10. The incident surface 101 is located at a lateral side of the light directing body 10. The light source 30 is located close to the light directing body 10 to emit light rays 31 into the light directing body 10.

The light rays 31 emitted from the light source 30 pass over the light directing particles 11 once or a number of times and are diffused so that the light directing body 10 becomes a planar light source with even luminosity. The advertising membrane 20 is bonded closely to the emitting surface 102. As the embodiments depicted in the drawings shown, two advertising membranes 20 are provided to be bonded to two emitting surfaces 102 on the upper side and lower side. The outer surface of the advertising membranes 20 has an advertising symbol 21 printed or bonded thereon to represent an intended brand or notation. The advertising membranes 20 may be bonded to the surface of the light directing body 10 a number of times repeatedly. Thus the advertising symbol 21 may be replaced according to user's requirements.

By means of the construction set forth above, when the light rays 31 enter the light directing body 10, the diffuse effect of the light directing particles 11 makes the light directing body 10 to become a planar light source of even luminosity. Thus deciphering of advertisement can be enhanced, and the billboard can be formed thinner and lighter. When LED is adopted as the light source 30, it also can save energy consumption to reduce user's operation cost.

What is claimed is:

1. An inner scattering billboard, comprising:
a light directing body which has at least one incident surface and at least one emitting surface, and contains a plurality of light directing particles inside in a scattering fashion;
a light source located closely to the incident surface to emit light rays into the light directing body; and
an advertising membrane which is bonded closely to the emitting surface and has an advertising symbol located on an outer surface thereof.

2. The inner scattering billboard of claim 1, wherein the advertising symbol is printed onto the advertising membrane.

3. The inner scattering billboard of claim 1, wherein the advertising symbol is bonded to the advertising membrane.

4. The inner scattering billboard of claim 1, wherein the light source is selected from the group consisting of a light emitting diode and a cold cathode fluorescent lamp.

5. The inner scattering billboard of claim 1, wherein the light directing body is a flat panel and has the emitting surface located respectively on an upper side and a lower side thereof the incident surface being located at a lateral side of the light directing body.

6. The inner scattering billboard of claim 1, wherein the light directing body is a slant panel and has the emitting surface located respectively on an upper side and a lower side thereof, the incident surface being located at a lateral side of the light directing body.

7. The inner scattering billboard of claim 1, wherein the advertising membrane is bondable to the surface of the light directing body a plurality of times repeatedly.
